(19) United States
(12) Patent Application Publication
(10) Pub. No.: US 2006/0266029 A1
(43) Pub. Date: Nov. 30, 2006

(54) Working machine

(75) Inventors: Tomohiko Asakage, Hiroshima-shi (JP); Yoshiyasu Umezu, Hiroshima-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KOBELCO CONSTRUCTION MACHINERY CO., LTD., Hiroshima-shi (JP)

(21) Appl. No.: 11/414,381

(22) Filed: May 1, 2006

(30) Foreign Application Priority Data
May 24, 2005 (JP) 2005-150734

(51) Int. Cl. F16D 31/02

(52) U.S. Cl. 60/486

(57) ABSTRACT

A working machine includes a hydraulic pump and a travel control valve for each of left and right traveling unit. A tank-side fluid channel of the travel control valve includes an actuator control valve for controlling another actuator. When both travel control valves are operated at the same time and when at least one actuator control valve is operated, a merge control valve is opened to merge hydraulic fluid ejected from the two hydraulic pumps. At the same time, a feed switching valve is opened so that a different hydraulic pump supplies hydraulic fluid to the actuator control valve.

### BACKGROUND OF THE INVENTION

1. Field of the Invention

The present invention relates to a working machine including a plurality of hydraulic pumps for each of a plurality of traveling units.

2. Description of the Related Art

Some hydraulic pressure supply apparatuses include left and right travel control valves that lead fluid ejected from first and second hydraulic pumps respectively corresponding to left and right travel motors and control valves provided in tank-side flow channels of the travel control valves in order to control other actuators. In such hydraulic pressure supply apparatuses, the left and right travel motors are driven by their respective hydraulic pumps and are independently controlled by operating the travel control valves. Also, the other actuators are driven by using hydraulic fluid flowing from the travel control valves to the tank-side flow channels.

In this case, when the travel control valve is open and the actuator control valve downstream of the travel control valve is also operated, the amount of the hydraulic fluid flowing from the travel control valve decreases compared with the case where all the amount of the hydraulic fluid flowing from the travel control valve is led to a tank. Accordingly, the flow amount of the hydraulic fluid flowing into the travel motor increases in proportion to the decrease. Thus, the traveling velocity due to the driving motor increases to a velocity higher than the velocity instructed by means of a driving lever. As a result, the traveling velocities on the left and the right sides of a working machine might be significantly unbalanced.

To solve this problem, Japanese Unexamined Patent Application Publication No. 5-126104 describes an apparatus including a straight-ahead travel control valve disposed between the first and second hydraulic pumps. This straight-ahead travel control valve opens when both first and second hydraulic pumps are operated and any one of the actuators is operated so as to merge hydraulic fluid from the first hydraulic pump and hydraulic fluid from the second hydraulic pump. Also, some of the hydraulic fluid is distributed to the actuator control valve. The merging of the hydraulic fluid ensures constant straight-ahead travel.

In this case, since some of the merged hydraulic fluid is distributed from the actuator control valve to the corresponding actuator, the amount of the hydraulic fluid supplied to the travel motor is decreased by the amount of this portion compared with the case where all the hydraulic fluid from the hydraulic pumps is fed to the travel motors, thus decreasing the traveling velocity. In particular, when the driving load on the actuator is significantly lower than the traveling load, the amount of hydraulic fluid flowing into the actuator increases, and therefore, the amount of hydraulic fluid flowing into the travel motor significantly decreases. As a result, the traveling velocity is significantly decreased compared with the traveling velocity for a working machine without such operation. This decrease may cause a shock.

### SUMMARY OF THE INVENTION

Accordingly, it is an object of the present invention to provide a working machine that includes a hydraulic pressure supply apparatus having left and right pumps respectively corresponding to left and light traveling unit and that can effectively prevent the decrease in a traveling velocity while maintaining constant straight-ahead travel even when other actuators are driven.

According to an embodiment of the present invention, a working machine includes left and right traveling units operating by means of the supply of hydraulic fluid from a hydraulic fluid supply source and a hydraulic pressure supply apparatus. The hydraulic pressure supply apparatus includes a first hydraulic pump serving as a hydraulic fluid supply source for supplying hydraulic fluid to the left traveling unit, a second hydraulic pump serving as a hydraulic fluid supply source for supplying hydraulic fluid to the right traveling unit, a first travel control valve disposed between the left traveling unit and the first hydraulic pump, the first travel control valve having a neutral position for directly leading the hydraulic fluid supplied from the first hydraulic pump to a tank-side flow channel, the first travel control valve leading an amount of the hydraulic fluid from the first hydraulic pump in proportion to an operational amount of the first travel control valve from the neutral position to another position to the left traveling unit, a second travel control valve disposed between the right traveling unit and the second hydraulic pump, the second travel control valve having a neutral position for directly leading the hydraulic fluid supplied from the second hydraulic pump to a tank-side flow channel, the second travel control valve leading an amount of the hydraulic fluid from the second hydraulic pump in proportion to an operational amount of the second control valve from the neutral position to another position to the right traveling unit, at least one actuator control valve connected to at least one of the tank-side flow channels of the first travel control valve and the second travel control valve, the actuator control valve being switchable between a neutral position and driving position, the neutral position meaning that hydraulic fluid flowing through the tank-side flow channel is directly led to the tank side, the driving position meaning that the hydraulic fluid flowing through the tank-side flow channel is led to a predetermined actuator different from the left and right traveling units, a straight-ahead travel control valve being switchable between a block position and merge position, the block position meaning that a first hydraulic supply channel starting from the first hydraulic pump to the first travel control valve is blocked from a second hydraulic supply channel starting from the second hydraulic pump to the second travel control valve, the merge position meaning that the first hydraulic supply channel is connected to the second hydraulic supply channel so as to merge hydraulic fluid ejected from the first hydraulic pump and hydraulic fluid ejected from the second hydraulic pump, a third hydraulic pump separately disposed from the first hydraulic pump and the second hydraulic pump, a hydraulic feed channel for leading hydraulic fluid ejected from the third hydraulic pump to the predetermined actuator so as to feed the hydraulic fluid to the predetermined actuator, a feed switching valve being switchable between a feed position and block position, the feed position meaning that the third hydraulic pump is connected to the hydraulic feed channel, the block position meaning that the third hydraulic pump is disconnected from the hydraulic feed channel, and switching control means. The switching control means switches the straight-ahead travel control valve and the feed switching valve to the block positions when at least one of the first travel control valve and the second travel control valve remains at the neutral position or when all of the actuator control valves remain at the neutral positions. Also, the switching control means switches the straight-ahead travel control valve to the merge position and the feed switching valve to the feed position when both the first travel control valve and the second travel control valve are operated from the neutral positions by a predetermined operational amount and when at least one of the actuator control valves is operated from the neutral position to the driving position.

According to the present invention, when both the first travel control valve and the second travel control valve are operated and at least one of the actuator control valves is operated, the straight-ahead travel control valve is open so as to merge the hydraulic fluid from the first hydraulic pump with the hydraulic fluid from the second hydraulic pump. At the same time, the feed switching valve is opened so that the third hydraulic pump different from the first and second hydraulic pump supplies hydraulic fluid to the actuator control valve. Consequently, the left and right traveling units can respectively have the first and second hydraulic pumps while ensuring a constant straight-ahead travel even when another actuator is driven. Additionally, a decrease in the traveling velocity can be efficiently prevented.

### BRIEF DESCRIPTION OF THE DRAWINGS

FIG. 1 is a circuit diagram of a hydraulic pressure supply apparatus of a working machine according to a first embodiment of the present invention;

FIG. 2 shows a schematic illustration of the structure of the whole working machine;

FIG. 3 is a circuit diagram of a hydraulic pressure supply apparatus of a working machine according to a second embodiment of the present invention;

FIG. 4 is a circuit diagram of a hydraulic pressure supply apparatus of a working machine according to a third embodiment of the present invention; and

FIG. 5 is a flow chart of an exemplary control of the hydraulic pressure supply apparatus of the working machine according to the third embodiment of the present invention.

### DESCRIPTION OF THE PREFERRED EMBODIMENTS

According to the present invention, a working machine has the above-described basic structure. Thus, when at least one of the first travel control valve and the second travel control valve remains at the neutral position (i.e., when straight-ahead traveling is not required) or when all of the actuator control valves remain at their neutral positions (i.e., when there is no possibility that straight-ahead traveling is prevented), the straight-ahead travel control valve and the feed switching valve are switched to their block positions so that the left and right traveling units can be independently driven by their respective hydraulic pumps. In contrast, when the first travel control valve and the second travel control valve are operated from their neutral positions by more than or equal to a predetermined amount and at least one of the actuator control valves is operated from the neutral position to driving position, the straight-ahead travel control valve is switched to the merge position so that the straight-ahead travel can be maintained. In addition, by switching the feed switching valve to the feed position in order to feed hydraulic fluid ejected from a third hydraulic pump different from the first and second hydraulic pumps to the operated actuator control valve, the actuator corresponding to the actuator control valve can be normally operated while maintaining the amount of hydraulic fluid delivered to the traveling unit corresponding to the travel control valve and preventing the decrease of the traveling velocity.

The components of the above-described basic structure can have the following structure.

Although the detailed structure is described below, the switching control means of the straight-ahead travel control valve and the feed switching valve may include an electromagnetic switching valve whose open and close operations are electrically controlled. The straight-ahead travel control valve may be composed of a pilot switching valve that can be switched from the block position to merge position when being supplied with a pilot pressure greater than or equal to a predetermined pressure. The feed switching valve may be composed of a pilot switching valve that can be switched from the block position to feed position when being supplied with a pilot pressure greater than or equal to a predetermined pressure. The switching control means can include a pilot hydraulic fluid supply source connected to both the straight-ahead travel control valve and the feed switching valve and a pilot pressure supply circuit. The pilot pressure supply circuit can cause both the straight-ahead travel control valve and the feed switching valve to remain at their block positions by restricting the supply of the pilot pressure from pilot hydraulic fluid supply source to the straight-ahead travel control valve and the feed switching valve when at least one of the first travel control valve and the second travel control valve remains at the neutral position or when all of the actuator control valves remain at their neutral positions. In contrast, the pilot pressure supply circuit can supply a pilot pressure from pilot hydraulic fluid supply source to the straight-ahead travel control valve and the feed switching valve sufficient to switch the straight-ahead travel control valve to the merge position and sufficient to switch the feed switching valve to the feed position when both the first travel control valve and the second travel control valve are operated from the neutral positions by a predetermined operational amount and when at least one of the actuator control valves is operated from the neutral position to the driving position.

In this case, the switching operations of the straight-ahead travel control valve and the feed switching valve can be properly controlled by using a simple structure in which both the straight-ahead travel control valve and the feed switching valve are connected to a single pilot hydraulic fluid supply source.

It is noted that a minimum value (a predetermined value) of the pilot pressure to switch the straight-ahead travel control valve to the merge position may be equal to a minimum value (a predetermined value) of the pilot pressure to switch the feed switching valve to the merge position. Alternatively the two predetermined values may be different to each other.

Furthermore, the pilot pressure supply circuit can include a pilot line for connecting the pilot hydraulic fluid supply source to the straight-ahead travel control valve and the feed switching valve, a travel-side cooperating switching valve disposed the pilot line and the tank and cooperating with each of the travel control valves, and an actuator-side cooperating switching valve disposed between the pilot line and the tank and cooperating with the actuator control valve. Each of the cooperating switching valves can connect the pilot line to the tank when one of the two travel control valves remains at the neutral position or when all of the actuator control valves remain at the neutral positions, and the cooperating switching valve can disconnect the pilot line from the tank when the two travel control valves are operated from their neutral positions by more than or equal to a predetermined amount and when at least one of the actuator control valves is operated from the neutral position to driving position.

In this case, the release operations of the pilot pressure (i.e., opening operations) from the pilot hydraulic fluid supply source to the straight-ahead travel control valve and the feed switching valve can be automatically activated by the switching operations of the cooperating switching valves corresponding to the travel control valves and the actuator control valves without the need to provide detecting means for detecting the operational states of the travel control valves and the actuator control valves.

Additionally, the actuator control valve may be provided to either one of the tank-side flow channels of the travel control valves. Alternatively, the actuator control valve may be provided to both. If the actuator control valve may be provided to both tank-side flow channels and the hydraulic feed channel is simply connected to the actuator control valves in both tank-side flow channels, there is a possibility that the hydraulic fluid from the two actuator control valves are merged via the hydraulic feed channel depending on the structure of the hydraulic feed channel even when the straight-ahead travel control valve and the feed switching valve remain at their block positions. Accordingly, the hydraulic feed channel can include a pump-side flow channel connecting the third hydraulic pump to the feed switching valve, a first branch flow channel connecting the feed switching valve to the actuator control valve of the first travel control valve, and a second branch flow channel connecting the feed switching valve to the actuator control valve of the second travel control valve. The feed switching valve can disconnect the pump-side flow channel from the first branch flow channel and disconnects the pump-side flow channel from the second branch flow channel when the feed switching valve remains at the block position, and the feed switching valve can connect the pump-side flow channel to the first branch flow channel and can connect the pump-side flow channel to the second branch flow channel when the feed switching valve remains at the feed position.

In this case, by switching the feed switching valve to the block position, the two branch flow channels can be kept separate from each other, thus preventing the merging of the hydraulic fluid from the two actuator control valves. In addition, by switching the feed switching valve to the feed position, the hydraulic fluid ejected from the third hydraulic pump can be delivered to the actuator control valves in the pump-side flow channels of the two travel control valves.

Alternatively, the hydraulic feed channel can include a pump-side flow channel for connecting the third hydraulic pump to the feed switching valve, an upstream fluid supply channel for connecting one of the actuator control valve of the first travel control valve and the actuator control valve of the second travel control valve to the straight-ahead travel control valve to the feed switching valve, and a downstream fluid supply channel for connecting the other one of the actuator control valves to the straight-ahead travel control valve. The feed switching valve can disconnect the pump-side flow channel from the upstream fluid supply channel when the feed switching valve remains at the block position, and the feed switching valve can connect the pump-side flow channel to the upstream fluid supply channel when the feed switching valve remains at the feed position. The straight-ahead travel control valve can disconnect the upstream fluid supply channel from the downstream fluid supply channel when the straight-ahead travel control-valve remains at the block position, and the straight-ahead travel control valve can connect the upstream fluid supply channel to the downstream fluid supply channel when the straight-ahead travel control valve remains at the merge position so as to feed the hydraulic fluid to the other one of the actuator control valves from the feed switching valve via the upstream fluid supply channel and the downstream fluid supply channel.

In this case, when the straight-ahead travel control valve is switched to the block position, the straight-ahead travel control valve disconnects the upstream fluid supply channel from the downstream fluid supply channel of the hydraulic feed channel. Accordingly, the merging of the hydraulic fluid from the actuator control valves via the upstream and downstream fluid supply channels can be prevented. In addition; when the straight-ahead travel control valve is switched to the merge position at the same time as the feed switching valve is switched to the feed position, the straight-ahead travel control valve connects the upstream fluid supply channel to the downstream fluid supply channel. Thus, the hydraulic fluid ejected from the third hydraulic pump can be delivered to the actuator control valves in the tank-side flow channels of the two travel control valves via the upstream fluid supply channel and the downstream fluid supply channel.

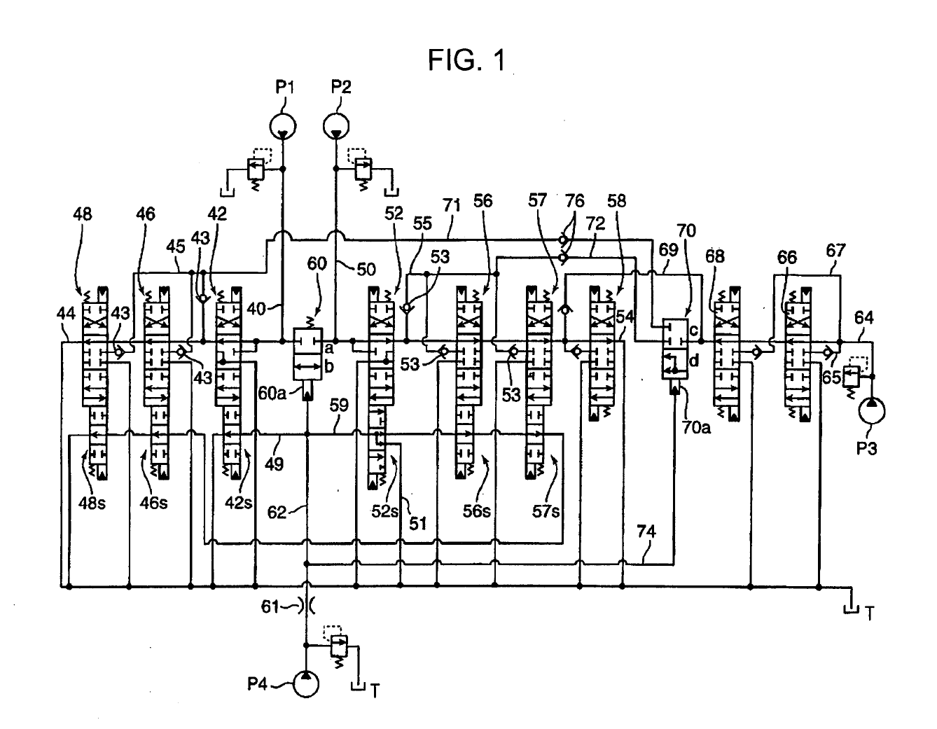

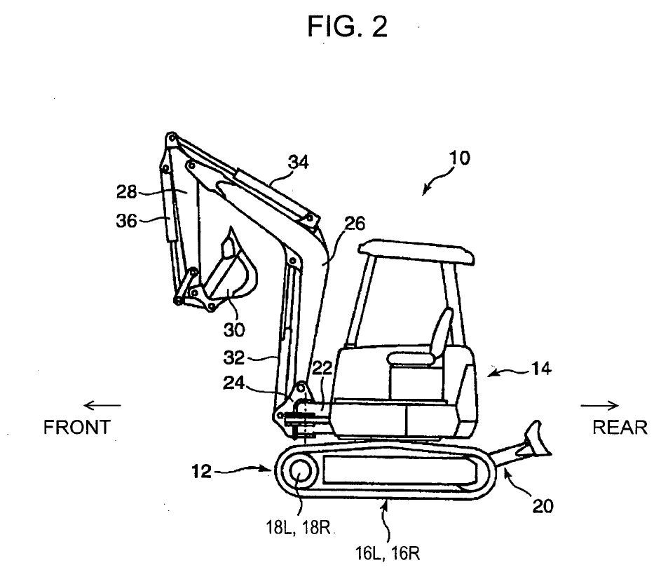

A first exemplary embodiment is now herein described with reference to FIGS. 1 and 2.

FIG. 2 shows a schematic illustration of the structure of a working machine (hydraulic excavator 10) according to a first embodiment of the present invention. The hydraulic excavator 10 includes a lower traveling body 12 and an upper rotating body 14 rotatably mounted on the lower traveling body 12. The hydraulic excavator 10 also incorporates a rotating motor composed of a hydraulic motor for rotating the upper rotating body 14 on the lower traveling body 12.

The lower traveling body 12 includes left and right traveling crawlers 16L and 16R. The traveling crawlers 16L and 16R include travel motors 18L and 18R composed of hydraulic motors for rotating ringers of the traveling crawlers 16L and 16R, respectively. A dozer 20 is attached to the frame of the lower traveling body 12. A dozer cylinder (not shown) is also provided to the frame of the lower traveling body 12 to swing the dozer 20 in a vertical direction.

A swing bracket 22 is attached to the front of the upper rotating body 14. A boom supporting member 24 is attached to the swing bracket 22 so as to be able to swing in the horizontal direction. A boom 26 is attached to the sheet pressure lever shaft 24 so as to be able to pivot in the vertical direction. An arm 28 is rotatably attached to the top of the boom 26. A bucket 30 is rotatably attached to the top of the arm 28. Here, the expansion and contraction of a boom swing cylinder (not shown), a boom cylinder 32, an arm cylinder 34, and a bucket cylinder 36 enable the swinging of the boom supporting member 24, the pivotal operation of the boom 26, the rotation of the arm 28 relative to the boom 26, and the rotation of the bucket 30 relative to the arm 28, respectively.

Additionally, in place of the bucket 30, an appropriate working attachment (e.g., a crusher) can be mounted on the top of the arm 28. The upper rotating body 14 has a pipe so that a hydraulic pressure can be provided to a cylinder (e.g., a crusher cylinder) for operating the attachment.

FIG. 1 illustrates a hydraulic pressure supply apparatus mounted in the working machine. This hydraulic pressure supply apparatus includes a first hydraulic pump P1, a second hydraulic pump P2, a third hydraulic pump P3, and a pilot pump P4. The first hydraulic pump P1, the second hydraulic pump P2, the third hydraulic pump P3 serve as hydraulic fluid supply sources such as hydraulic oil supply sources for supplying hydraulic pressure to hydraulic actuators, such as the above-described hydraulic cylinders and hydraulic motor, while the pilot pump P4 serves as a pilot hydraulic fluid supply source.

A discharging port of the first hydraulic pump P1 is connected to a primary port of a first travel control valve 42 via a first hydraulic fluid supply channel 40. Similarly, a discharging port of the second hydraulic pump P2 is connected to a primary port of a second travel control valve 52 via a second hydraulic fluid supply channel 50. Each of the first and second travel control valves 42 and 52 is composed of a three-position pilot-operated directional control valve having three positions and is switchable between the three positions by a pilot operation of a travel remote-control valve (not shown).

When the first travel control valve 42 is set at the neutral position (a middle position in FIG. 1), the first travel control valve 42 directly leads all amounts of the hydraulic fluid fed from the first hydraulic pump P1 via the first hydraulic fluid supply channel 40 to a tank-side flow channel 44. When the first travel control valve 42 is operated by a lever operation of a travel remote-control valve so as to move to the upper position or the lower position shown in FIG. 1, the first travel control valve 42 leads the hydraulic fluid fed from the first hydraulic fluid supply channel 40 to the left travel motor 18L by an amount defined by the operation amount in a direction defined by the operation. Similarly, when the second travel control valve 52 is set at the neutral position (a middle position in FIG. 1), the second travel control valve 52 directly leads all amounts of the hydraulic fluid fed from the second hydraulic pump P2 via the second hydraulic fluid supply channel 50 to a tank-side flow channel 54. When the second travel control valve 52 is operated by a lever operation of a travel remote-control valve so as to move to the upper position or the lower position shown in FIG. 1, the second travel control valve 52 leads the hydraulic fluid fed from the second hydraulic fluid supply channel 50 to the right travel motor 18R by an amount defined by the operation amount in a direction defined by the operation.

Additionally, as actuator valves according to the present invention, a boom control valve 46 and a bucket control valve 48 are disposed in series in the tank-side flow channel 44 of the first travel control valve 42 from the upstream side. Similarly, a boom swing control valve 56 and an arm control valve 57 are disposed in series in the tank-side flow channel 54 of the second travel control valve 52 from the upstream side. Furthermore, downstream of the arm control valve 57, a service control valve 58 is provided.

Like the first and second travel control valves 42 and 52, each of the control valves 46, 48, 56, 57, and 58 is composed of a three-position pilot-operated directional control valve. Each of the pilot-operated directional control valves includes a center bypass port connected to the tank-side flow channel 44, an inlet port connected to a supply flow channel 45 or 55) that branches from the tank-side flow channel 44 (or 54) immediately downstream of the first travel control valve 42 (or the second travel control valve 52), and a tank port connected to a tank. When each of the pilot-operated directional control valves is set at the neutral position (a middle position in FIG. 1), the pilot-operated directional control valve directly leads all amounts of the hydraulic fluid fed from the upstream (i.e., the first travel control valve 42 or the second travel control valve 52) to the tank side. When each of the pilot-operated directional control valves is operated so as to be moved to the upper position or the lower position shown in FIG. 1, the pilot-operated directional control valve closes the center bypass port and connects the inlet port and the tank port to predetermined actuators so that the hydraulic fluid supplied from the tank-side flow channel 44 (or 54) via the supply flow channel 45 (or 55) is led to the predetermined actuators in a direction corresponding to the operational direction.

Examples of the connection between the inlet port and the predetermined actuator and the connection between the tank port and the predetermined actuator include a connection between the boom control valve 46 and the boom cylinder 32, a connection between the bucket control valve 48 and the bucket cylinder 36, a connection between the boom swing control valve 56 and the boom swing cylinder, a connection between the arm control valve 57 and the arm cylinder 34, and a connection between the service control valve 58 and a cylinder incorporated in an attachment.

It is noted that back-flow prevention valves 43 are provided at appropriate positions in the supply flow channel 45. Similarly, back-flow prevention valves 53 are provided at appropriate positions in the supply flow channel 55.

In addition, a straight-ahead travel control valve 60 is disposed between the first hydraulic fluid supply channel 40 and the second hydraulic fluid supply channel 50. The straight-ahead travel control valve 60 is composed of a two-position pilot-operated directional control valve including a pilot chamber 60a, which is connected to the pilot pump P4 via a pilot line 62. The pilot line 62 includes an aperture 61. The straight-ahead travel control valve 60 has two positions: a blocking position a at which the first hydraulic fluid supply channel 40 is blocked from the second hydraulic fluid supply channel 50; and a merge position b at which hydraulic fluid from the first hydraulic pump P1 and hydraulic fluid from the second hydraulic pump P2 are allowed to merge by connecting the first hydraulic fluid supply channel 40 with the second hydraulic fluid supply channel 50. When a pilot pressure less than a predetermined value is applied to the pilot chamber 60a, the straight-ahead travel control valve 60 remains at the blocking position a. In contrast, when a pilot pressure greater than or equal to the predetermined value is applied to the pilot chamber 60a, the straight-ahead travel control valve 60 is switched from the blocking position a to the merge position b.

A discharging port of the third hydraulic pump P3 is connected to a primary port of a feed switching valve 70 via a center bypass line (pump-side fluid channel) 64. A dozer control valve 66 and a turn control valve 68 are disposed in that order from the upstream side to the downstream side in the center bypass line 64. Like the above-described actuator control valves, the dozer control valve 66 and the turn control valve 68 are composed of a three-position pilot-operated directional control valve. When the pilot-operated directional control valve is located at the neutral position (a middle position in FIG. 1), all amounts of hydraulic fluid supplied from the third hydraulic pump P3 pass directly through the center bypass line 64. In contrast, when the pilot-operated directional control valve is operated from the neutral position to the upper position or the lower position shown in FIG. 1, the center bypass line 64 is blocked. Concurrently, hydraulic fluid supplied from supply fluid channels 65 and 67 which branch from the center bypass line 64 is led to predetermined actuators in a direction corresponding to the operational direction (i.e., the hydraulic fluid is led from the dozer control valve 66 to a dozer cylinder and is led from the turn control valve 68 to a turn motor).

The feed switching valve 70 is composed of a two-position pilot-operated directional control valve including one primary port and two secondary ports. A pilot chamber 70a of the feed switching valve 70 is connected to a pilot line 74 which branches from the pilot line 62 at a position downstream of the aperture 61. One of the secondary ports is connected to the supply flow channel 45 via a first branch fluid channel 71 while the other of the secondary ports is connected to the supply flow channel 55 via a second branch fluid channel 72. Back-flow prevention valves 76 are provided at appropriate positions in the first branch fluid channel 71 and the second branch fluid channel 72.

The feed switching valve 70 has two positions: a blocking position c at which the center bypass line 64 is blocked from the first branch fluid channel 71 and the second branch fluid channel 72; and a supply position d at which the center bypass line 64 is connected to the first branch fluid channel 71 and the second branch fluid channel 72 so that the fluid ejected from the third hydraulic pump P3 is led to the supply flow channels 45 and 55. In such a structure, when a pilot pressure less than a predetermined value is applied to the pilot chamber 70a, the feed switching valve 70 remains at the blocking position c. While, when a pilot pressure greater than or equal to the predetermined value is applied to the pilot chamber 70a, the feed switching valve 70 is switched from the blocking position c to the supply position d.

Additionally, a fluid supply channel 69 branches from the center bypass line 64 at a position immediately upstream of the feed switching valve 70. The fluid supply channel 69 is connected to a primary port of the service control valve 58. The third hydraulic pump P3 can deliver the discharging fluid thereof to the service control valve 58 without the fluid passing through the feed switching valve 70.

Furthermore, a pilot circuit connected to the pilot pump P4 includes means for releasing the pilot pressure applied to the pilot chambers 60a of the straight-ahead travel control valve 60 and the pilot chamber 70a of the feed switching valve 70 in addition to the pilot lines 62 and 74.

More specifically, a first pilot pressure release line 49 and a second pilot pressure release line 59 branch from the pilot line 62, both of which are individually led to a tank T. The first pilot pressure release line 49 intermediately includes a sub-valve 42s provided to the first travel control valve 42. Additionally, the second pilot pressure release line 59 intermediately includes a sub-valve 52s provided to the second travel control valve 52, a sub-valve 56s provided to the boom swing control valve 56, a sub-valve 57s provided to the arm control valve 57, a sub-valve 46s provided to the boom control valve 46, and a sub-valve 48s provided to the bucket control valve 48 in series in that order from the upstream side.

The sub-valves 42s, 52s, 56s, 57s, 46s, and 48s work so as to open and close in cooperation with the control valves 42, 52, 56, 57, 46, and 48, respectively.

With the exception of the sub-valve 52s of the second travel control valve 52, the sub-valves 42s, 56s, 57s, 46s, and 48s maintain the open positions that allow the corresponding pilot pressure release lines (i.e., the first pilot pressure release line 49 for the sub-valve 42s, the second pilot pressure release line 59 for the other sub-valves) to be opened when the corresponding control valves 42, 56, 57, 46, and 48 are at their neutral positions. In contrast, when the control valves 42, 56, 57, 46, and 48 are operated to move from their neutral positions by predetermined operational amount or more, the sub-valves 42s, 56s, 57s, 46s, and 48s switch their positions to block positions so that the corresponding pilot pressure release lines are blocked.

In contrast, the sub-valve 52s of the second travel control valve 52 opens the second pilot pressure release line 59 regardless of the operating position of the second travel control valve 52. In addition, when the second travel control valve 52 remains at the neutral position, the sub-valve 52s connects the second pilot pressure release line 59 to the tank T via a tank fluid channel 51.

The operation of this apparatus is described next.

First, when the first travel control valve 42 or the second travel control valve 52 is not operated so as to remain at the neutral position, the pilot line 62 is directly connected to the tank T via the sub-valve 42s of the first travel control valve 42 or the sub-valve 52s of the second travel control valve 52. Accordingly, a pilot pressure is not generated in the pilot line 62, and therefore, the straight-ahead travel control valve 60 remains at the block position a. Consequently, the first hydraulic fluid supply channel 40 of the first hydraulic pump P1 is blocked from the second hydraulic fluid supply channel 50 of the second hydraulic pump P2 so that the hydraulic pressure delivery from the first hydraulic pump P1 to the first travel control valve 42 is carried out independently from the hydraulic pressure delivery from the second hydraulic pump P2 to the second travel control valve 52.

In addition, since no pilot pressure is generated in the pilot line 74 communicating with the pilot line 62, the feed switching valve 70 also remains at the block position c. Accordingly, the hydraulic pressure is not also delivered from the center bypass line 64 on the third hydraulic pump P3 side.

Even when the first travel control valve 42 and the second travel control valve 52 are operated from their neutral positions by the predetermined operational amount or more, the sub-valves 56s, 57s, 46s, and 48s of the control valves 56, 57, 46, and 48 and the sub-valve 52s of the second travel control valve 52 are all open so as to open the second pilot pressure release line 59 if the control valves 56, 57, 46, and 48 are not operated and remain at their neutral positions. Accordingly, the second pilot pressure release line 59 connects the pilot line 62 to the tank T. As a result, as in the above-described case, a pilot pressure is not generated, and therefore, the straight-ahead travel control valve 60 and the feed switching valve 70 remain at the block position a and the block position c, respectively.

That is, when at least one of the first travel control valve 42 and the second travel control valve 52 is not operated (i.e., when straight-ahead traveling is not required) or when no actuator control valves are operated (i.e., when there is no possibility that straight-ahead traveling is prevented), neither the discharging fluid from the first hydraulic pump P1 and the discharging fluid from the second hydraulic pump P2 are merged nor hydraulic pressure is supplied from the third hydraulic pump P3.

In addition, since the first branch fluid channel 71 is disconnected from the second branch fluid channel 72 by the feed switching valve 70 which remains at the block position c, there is no possibility that fluid ejected from the first hydraulic pump P1 and fluid ejected from the second hydraulic pump P2 are merged via the first branch fluid channel 71 and the second branch fluid channel 72.

In contrast, when the first travel control valve 42 and the second travel control valve 52 are operated from their neutral positions by the predetermined operational amount or more and when at least one of the actuator control valves 56, 57, 46, and 48 is moved from the neutral position to the driving position, the sub-valve 42s of the first travel control valve 42 blocks the first pilot pressure release line 49 and the sub-valve of the control valve that is moved to the driving position blocks the second pilot pressure release line 59. Accordingly, a pilot pressure is generated in the pilot line 62 and the pilot line 74 so that the position of the straight-ahead travel control valve 60 is switched to the merge position b and the position of the feed switching valve 70 is switched to the supply position d. Consequently, the discharging fluid from the first hydraulic pump P1 is merged with the discharging fluid from the second hydraulic pump P2 via the straight-ahead travel control valve 60, thus ensuring constant straight-ahead travel. In addition, via the feed switching valve 70 and the first branch fluid channel 71 or via the feed switching valve 70 and the second branch fluid channel 72, the discharging fluid from the third hydraulic pump P3 is delivered to the actuator control valve to be operated (i.e., the control valve that is moved to the driving position). As a result, the decrease in traveling velocity due to the decrease in the amount of operational fluid supplied to the travel motors 18L and 18R caused by the operation of that actuator control valve can be efficiently prevented.

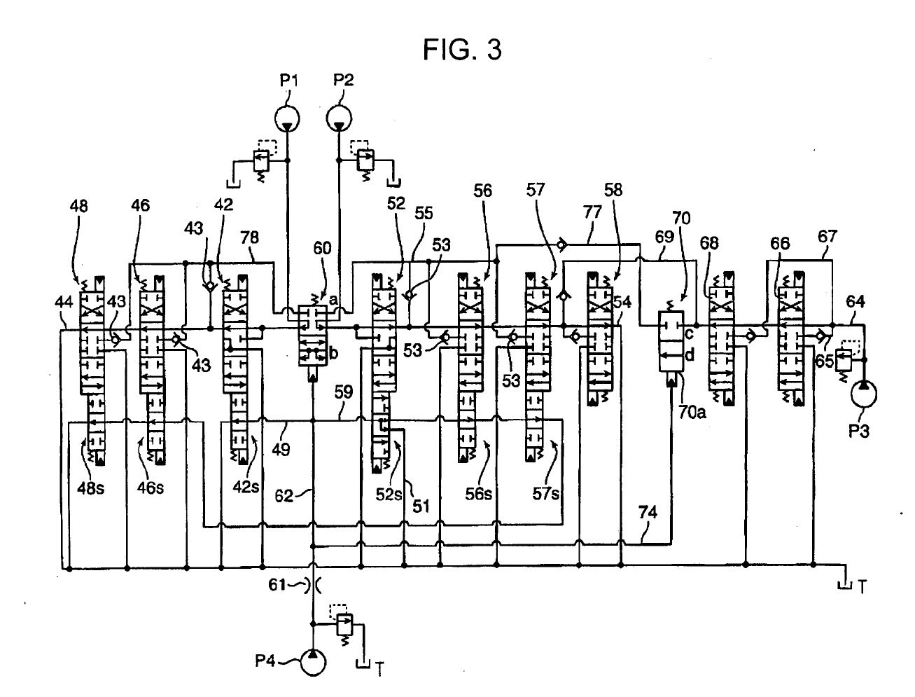

While the first embodiment has been described with reference to the structure in which the first branch fluid channel 71 for delivering the discharging fluid from the third hydraulic pump P3 to the control valves 46 and 48 on the first hydraulic pump P1 side and the second branch fluid channel 72 for delivering the discharging fluid from the third hydraulic pump P3 to the control valves 56, 57, and 58 on the second hydraulic pump P2 side are disposed in parallel, the structure is not limited thereto. That is, as shown in FIG. 3 which illustrates a second embodiment, an upstream fluid supply channel 78, which is a supply flow channel to the control valves 46 and 48 on the first hydraulic pump P1 side, and a downstream fluid supply channel 77, which is a supply flow channel to the control valves 56 and 57 on the second hydraulic pump P2 side, may be disposed in series, and only the downstream fluid supply channel 77 may be connected to the secondary port of the feed switching valve 70. In this case, as shown in FIG. 3, the upstream fluid supply channel 78 and the downstream fluid supply channel 77 are connected to the straight-ahead travel control valve 60 so that the straight-ahead travel control valve 60 is disposed between the upstream and downstream fluid supply channels 77 and 78. When the straight-ahead travel control valve 60 remains at the block position a, the upstream fluid supply channel 78 is blocked from the downstream fluid supply channel 77. When the straight-ahead travel control valve 60 remains at the merge position b, the straight-ahead travel control valve 60 connects the upstream fluid supply channel 78 to the downstream fluid supply channel 77. This structure allows appropriate connection and disconnection between the two fluid supply flow channels 78 and 77 to be realized by efficiently using the straight-ahead travel control valve 60. That is, when blocking the merging of hydraulic fluid from the first hydraulic pump P1 and the hydraulic fluid from the second hydraulic pump P2, the upstream fluid supply channel 78 is disconnected from the downstream fluid supply channel 77 so that the merging of the hydraulic fluid from the upstream fluid supply channel 78 and the hydraulic fluid from the downstream fluid supply channel 77 is prevented. When merging hydraulic fluid from the first hydraulic pump P1 and the hydraulic fluid from the second hydraulic pump P2, the upstream fluid supply channel 78 is connected to the downstream fluid supply channel 77 so that the hydraulic fluid ejected from the third hydraulic pump P3 can be delivered to the control valves 56 and 57, and, what is more, the control valves 46 and 48.

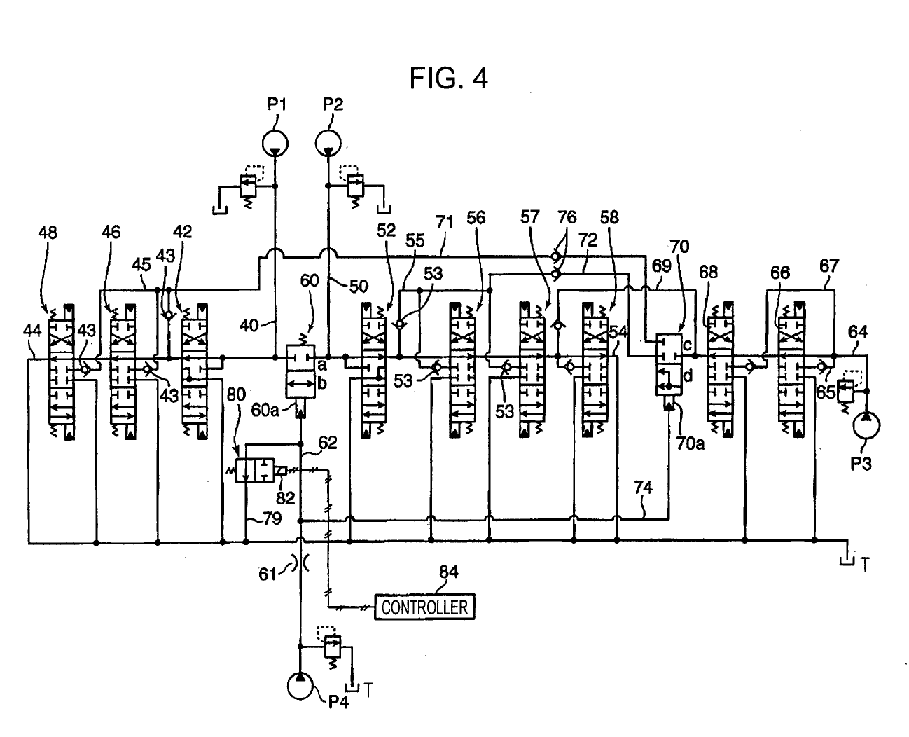

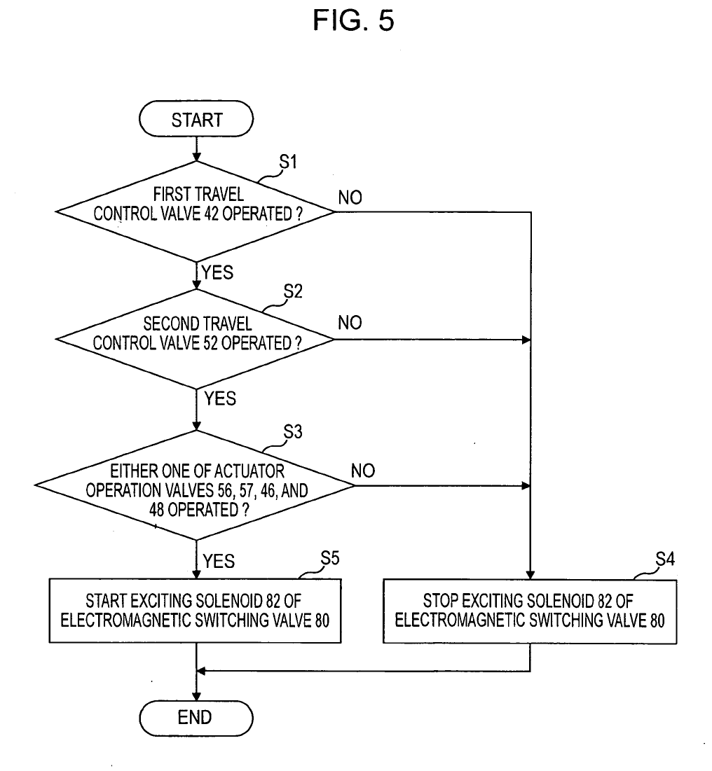

Furthermore, the pilot pressure of the straight-ahead travel control valve 60 and the feed switching valve 70 may be electrically controlled. A third embodiment describes this example with reference to FIGS. 4 and 5.

As shown in FIG. 4, a circuit includes a pilot pressure release line 79 that branches from the pilot line 62 and reaches the tank T. The circuit further includes an electromagnetic switching valve 80 at some position in the pilot pressure release line 79. The electromagnetic switching valve 80 remains at an open position which opens the pilot pressure release line 79 when a solenoid 82 thereof is not excited. When the solenoid 82 is excited, the electromagnetic switching valve 80 is switched from that position to a blocking position so that the pilot pressure release line 79 is closed. The excitation state of the solenoid 82 of the electromagnetic switching valve 80 can be switched by a controller 84 including a microcomputer.

The controller 84 receives detection signals of the operational strokes of the two travel control valves 42 and 52 and the control valves 56, 57, 46, and 48 (e.g., a detection signal from a stroke sensor or detection signal from a pressure sensor for detecting-pilot pressure). Subsequently, the controller 84 controls the excitation state of the solenoid 82 on the basis of the detection signal.

More specifically, as shown in a flow chart of FIG. 5, when the first travel control valve 42 is not operated and remains at the neutral position (NO at step S1) or when the second travel control valve 52 is not operated and remains at the neutral position (NO at step S2) or when neither one of the actuator control valves 56, 57, 46, and 48 is operated (NO at step S3), the excitation of the solenoid 82 of the electromagnetic switching valve 80 is stopped (step S4) so that the electromagnetic switching valve 80 is opened. Accordingly, a pilot pressure of the pilot line 62 is released, and the straight-ahead travel control valve 60 and the feed switching valve 70 remain at the block positions a and c, respectively.

In contrast, when both the first travel control valve 42 and the second travel control valve 52 are operated from their neutral positions by predetermined operational amount or more (YES at step S1) and when one of the actuator control valves 56, 57, 46, and 48 is operated to the driving position (YES at step S3), the excitation of the solenoid 82 of the electromagnetic switching valve 80 is activated so that the electromagnetic switching valve 80 is switched to the block position. Thus, a pilot pressure is generated in the pilot line 62, and the straight-ahead travel control valve 60 and the feed switching valve 70 are switched to the merge position b and the supply position d, respectively.

This structure can provide the same advantages as those of the apparatuses shown in FIGS. 1 and 3.

Alternatively, the present invention can provide the following embodiment.

An actuator control valve may be provided downstream of either one of the first travel control valve 42 and the second travel control valve 52. In this case, for example, the first branch fluid channel 71 or the second branch fluid channel 72 shown in FIG. 1 can be eliminated. Additionally, the total number of the actuator control valves may be any number.

The amounts of operation from the neutral positions of the first travel control valve 42 and the second travel control valve 52 that determine the start of the merging for straight-ahead traveling and the supply from the third hydraulic pump P3 can be appropriately determined. For example, the merging and the supply may be started when the first travel control valve 42 and the second travel control valve 52 are slightly operated. Alternatively, the merge and the supply may be started when the first travel control valve 42 and the second travel control valve 52 are operated beyond a maximum velocity level, under which the straight-ahead traveling is not serious. In addition, the timing of starting the merging by the straight-ahead travel control valve 60 may be slightly shifted from the timing of the supply by the feed switching valve 70.

In the above-described apparatuses, pilot pressure in the straight-ahead travel control valve 60 and the feed switching valve 70 is released by opening the connection between the first pilot pressure release line 49 and the second pilot pressure release line 59. However, by limiting the pilot pressure to less than a predetermined value, the straight-ahead travel control valve 60 and the feed switching valve 70 can remain at the block positions a and c, respectively. For example, the sub-valves 42s, 46s, 48s, 52s, 56s, and 57s may include a slight aperture at the opening positions thereof.

Although the invention has been described with reference to the preferred embodiments in the attached figures, it is noted that equivalents may be employed and substitutions made herein without departing from the scope of the invention as recited in the claims.

What is claimed is:

1. A working machine comprising:
left and right traveling units operating by means of the supply of hydraulic fluid from a hydraulic fluid supply source; and
a hydraulic pressure supply apparatus, the hydraulic pressure supply apparatus including:
a first hydraulic pump serving as a hydraulic fluid supply source for supplying hydraulic fluid to the left traveling unit;
a second hydraulic pump serving as a hydraulic fluid supply source for supplying hydraulic fluid to the right traveling unit;
a first travel control valve disposed between the left traveling unit and the first hydraulic pump, the first travel control valve having a neutral position for directly leading the hydraulic fluid supplied from the first hydraulic pump to a tank-side flow channel, the first travel control valve leading an amount of the hydraulic fluid from the first hydraulic pump in proportion to an operational amount of the first travel control valve from the neutral position to another position to the left traveling unit;
a second travel control valve disposed between the right traveling unit and the second hydraulic pump, the second travel control valve having a neutral position for directly leading the hydraulic fluid supplied from the second hydraulic pump to a tank-side flow channel, the second travel control valve leading an amount of the hydraulic fluid from the second hydraulic pump in proportion to an operational amount of the second control valve from the neutral position to another position to the right traveling unit;
at least one actuator control valve connected to at least one of the tank-side flow channels of the first travel control valve and the second travel control valve, the actuator control valve being switchable between a neutral position and driving position, the neutral position meaning that hydraulic fluid flowing through the tank-side flow channel is directly led to the tank side, the driving position meaning that the hydraulic fluid flowing through the tank-side flow channel is led to a predetermined actuator different from the left and right traveling units;
a straight-ahead travel control valve being switchable between a block position and merge position, the block position meaning that a first hydraulic supply channel starting from the first hydraulic pump to the first travel control valve is blocked from a second hydraulic supply channel starting from the second hydraulic pump to the second travel control valve, the merge position meaning that the first hydraulic supply channel is connected to the second hydraulic supply channel so as to merge hydraulic fluid ejected from the first hydraulic pump and hydraulic fluid ejected from the second hydraulic pump;
a third hydraulic pump separately disposed from the first hydraulic pump and the second hydraulic pump;
a hydraulic feed channel for leading hydraulic fluid ejected from the third hydraulic pump to the predetermined actuator so as to feed the hydraulic fluid to the predetermined actuator;
a feed switching valve being switchable between a feed position and block position, the feed position meaning that the third hydraulic pump is connected to the hydraulic feed channel, the block position meaning that the third hydraulic pump is disconnected from the hydraulic feed channel; and
switching control means for switching the straight-ahead travel control valve and the feed switching valve to the block positions when at least one of the first travel control valve and the second travel control valve remains at the neutral position or when all of the actuator control valves remain at the neutral positions and switching the straight-ahead travel control valve to the merge position and the feed switching valve to the feed position when both the first travel control valve and the second travel control valve are operated from the neutral positions by a predetermined operational amount and when at least one of the actuator control valves is operated from the neutral position to the driving position.

2. The working machine according to claim 1, wherein the straight-ahead travel control valve includes a pilot-operated directional control valve capable of being switched from the block position to the merge position when receiving a pilot pressure greater than or equal to a predetermined pressure, and the feed switching valve includes a pilot-operated directional control valve capable of being switched from the block position to the feed position when receiving a pilot pressure greater than or equal to a predetermined pressure, and wherein the switching control means further includes a pilot pressure supply circuit and a pilot hydraulic fluid supply source connected to the straight-ahead travel control valve and the feed switching valve, and wherein the pilot pressure supply circuit limits the supply of pilot pressure from the pilot hydraulic fluid supply source to the straight-ahead travel control valve and the feed switching valve so as to switch the straight-ahead travel control valve and the feed switching valve to the block positions when at least one of the first travel control valve and the second travel control valve remains at the neutral position or when all of the actuator control valves remain at the neutral positions, and wherein the pilot pressure supply circuit switches the straight-ahead travel control valve to the merge position and leads a pilot pressure sufficient for switching the feed switching valve to the feed position from the pilot hydraulic fluid supply source to the straight-ahead travel control valve and the feed switching valve when both the first travel control valve and the second travel control valve are operated from the neutral positions by more than or equal to a predetermined amount and when at least one of the actuator control valves is operated from the neutral position to the driving position.

3. The working machine according to claim 2, wherein the pilot pressure supply circuit includes a pilot line for connecting the pilot hydraulic fluid supply source to the straight-ahead travel control valve and the feed switching valve and a cooperating switching valve provided to each of the travel control valves and actuator control valves and disposed between the pilot line and the tank, and the cooperating switching valve opens and closes in cooperation with the corresponding travel control valve and actuator control valve, and wherein the cooperating switching valve connects the pilot line to the tank when one of the two travel control valves remains at the neutral position or when all of the actuator control valves remain at the neutral positions, and wherein the cooperating switching valve disconnects the pilot line from the tank when the two travel control valves are operated from the neutral positions by more than or equal to a predetermined amount and when at least one of the actuator control valves is operated from the neutral position to the driving position.

4. The working machine according to claim 1, wherein the actuator control valve is provided to both the tank-side flow channel of the first travel control valve and the tank-side flow channel of the second travel control valve, and wherein the hydraulic feed channel includes a pump-side flow channel connecting the third hydraulic pump to the feed switching valve, a first branch flow channel connecting the feed switching valve to the actuator control valve of the first travel control valve, and a second branch flow channel connecting the feed switching valve to the actuator control valve of the second travel control valve, and wherein the feed switching valve disconnects the pump-side flow channel from the first branch flow channel and disconnects the pump-side flow channel from the second branch flow channel when the feed switching valve remains at the block position, and wherein the feed switching valve connects the pump-side flow channel to the first branch flow channel and connects the pump-side flow channel to the second branch flow channel when the feed switching valve remains at the feed position.

5. The working machine according to claim 2, wherein the actuator control valve is provided to a tank-side flow channel of the first travel control valve and a tank-side flow channel of the second travel control valve, and wherein the hydraulic feed channel includes a pump-side flow channel connecting the third hydraulic pump to the feed switching valve, a first branch flow channel connecting the feed switching valve to the actuator control valve of the first travel control valve, and a second branch flow channel connecting the feed switching valve to the actuator control valve of the second travel control valve and wherein the feed switching valve disconnects the pump-side flow channel from the first branch flow channel and disconnects the pump-side flow channel from the second branch flow channel when the feed switching valve remains at the block position, and wherein the feed switching valve connects the pump-side flow channel to the first branch flow channel and connects the pump-side flow channel to the second branch flow channel when the feed switching valve remains at the feed position.

6. The working machine according to claim 3, wherein the actuator control valve is provided to a tank-side flow channel of the first travel control valve and a tank-side flow channel of the second travel control valve, and wherein the hydraulic feed channel includes a pump-side flow channel connecting the third hydraulic pump to the feed switching valve, a first branch flow channel connecting the feed switching valve to the actuator control valve of the first travel control valve, and a second branch flow channel connecting the feed switching valve to the actuator control valve of the second travel control valve and wherein the feed switching valve disconnects the pump-side flow channel from the first branch flow channel and disconnects the pump-side flow channel from the second branch flow channel when the feed switching valve remains at the block position, and wherein the feed switching valve connects the pump-side flow channel to the first branch flow channel and connects the pump-side flow channel to the second branch flow channel when the feed switching valve remains at the feed position.

7. The working machine according to claim 1, wherein the actuator control valve is provided to a tank-side flow channel of the first travel control valve and a tank-side flow channel of the second travel control valve, and wherein the hydraulic feed channel includes a pump-side flow channel connecting the third hydraulic pump to the feed switching valve, an upstream fluid supply channel connecting one of the actuator control valve of the first travel control valve and the actuator control valve of the second travel control valve to the feed switching valve and connecting the straight-ahead travel control valve to the feed switching valve, and a downstream fluid supply channel connecting the other one of the actuator control valves to the straight-ahead travel control valve, and wherein the feed switching valve disconnects the pump-side flow channel from the upstream fluid supply channel when the feed switching valve remains at the block position, and wherein the feed switching valve connects the pump-side flow channel to the upstream fluid supply channel when the feed switching valve remains at the feed position, and wherein the straight-ahead travel control valve disconnects the upstream fluid supply channel from the downstream fluid supply channel when the straight-ahead travel control valve remains at the block position, and wherein the straight-ahead travel control valve connects the upstream fluid supply channel to the downstream fluid supply channel when the straight-ahead travel control valve remains at the merge position so as to feed the hydraulic fluid to the other one of the actuator control valves from the feed switching valve via the upstream fluid supply channel and the downstream fluid supply channel.

8. The working machine according to claim 2, wherein the actuator control valve is provided to a tank-side flow channel of the first travel control valve and a tank-side flow channel of the second travel control valve, and wherein the hydraulic feed channel includes a pump-side flow channel connecting the third hydraulic pump to the feed switching valve, an upstream fluid supply channel connecting one of the actuator control valve of the first travel control valve and the actuator control valve of the second travel control valve to the feed switching valve and connecting the straight-ahead travel control valve to the feed switching valve, and a downstream fluid supply channel connecting the other one of the actuator control valves to the straight-ahead travel control valve, and wherein the feed switching valve disconnects the pump-side flow channel from the upstream fluid supply channel when the feed switching valve remains at the block position, and wherein the feed switching valve connects the pump-side flow channel to the upstream fluid supply channel when the feed switching valve remains at the feed position, and wherein the straight-ahead travel control valve disconnects the upstream fluid supply channel from the downstream fluid supply channel when the straight-ahead travel control valve remains at the block position, and wherein the straight-ahead travel control valve connects the upstream fluid supply channel to the downstream fluid supply channel when the straight-ahead travel control valve remains at the merge position so as to feed the hydraulic fluid to the other one of the actuator control valves from the feed switching valve via the upstream fluid supply channel and the downstream fluid supply channel.

9. The working machine according to claim 3, wherein the actuator control valve is provided to a tank-side flow channel of the first travel control valve and a tank-side flow channel of the second travel control valve, and wherein the hydraulic feed channel includes a pump-side flow channel connecting the third hydraulic pump to the feed switching valve, an upstream fluid supply channel connecting one of the actuator control valve of the first travel control valve and the actuator control valve of the second travel control valve to the feed switching valve and connecting the straight-ahead travel control valve to the feed switching valve, and a downstream fluid supply channel connecting the other one of the actuator control valves to the straight-ahead travel control valve, and wherein the feed switching valve disconnects the pump-side flow channel from the upstream fluid supply channel when the feed switching valve remains at the block position, and wherein the feed switching valve connects the pump-side flow channel to the upstream fluid supply channel when the feed switching valve remains at the feed position, and wherein the straight-ahead travel control valve disconnects the upstream fluid supply channel from the downstream fluid supply channel when the straight-ahead travel control valve remains at the block position, and wherein the straight-ahead travel control valve connects the upstream fluid supply channel to the downstream fluid supply channel when the straight-ahead travel control valve remains at the merge position so as to feed the hydraulic fluid to the other one of the actuator control valves from the feed switching valve via the upstream fluid supply channel and the downstream fluid supply channel.
